(19) United States
(12) Patent Application Publication
(10) Pub. No.: US 2025/0160326 A1
(43) Pub. Date: May 22, 2025

(54) METHODS OF CONTROLLING CAUSAL AGENTS OF SHEATH BLIGHT IN RICE

(71) Applicant: GOWAN COMPANY, L.L.C., Yuma, AZ (US)

(72) Inventor: Craig A. SANDOSKI, Collierville, TN (US)

(21) Appl. No.: 18/837,552

(22) PCT Filed: Feb. 8, 2023
(86) PCT No.: PCT/US2023/062220

§ 371 Date: Aug. 9, 2024

Related U.S. Application Data
(60) Provisional application No. 63/308,282, filed on Feb. 9, 2022.

(51) Int. Cl. A01N 41/10; A01P 3/00

(52) U.S. Cl. CPC A01N 41/10; A01P 3/00

(57) ABSTRACT

Methods of prevention, control and/or suppression of sheath blight in rice are provided. The methods generally involve applying a composition comprising benzobicyclon and/or benzobicyclon hydrolysate to rice seed, a rice plant or field of rice plants, or an area that comprise(s), or is susceptible to, sheath blight.

### CROSS-REFERENCE TO RELATED APPLICATION

This application claims priority to U.S. Provisional Patent Application Ser. No. 63/308,282 filed on Feb. 9, 2022, the contents of which is incorporated herein by reference in its entirety.

### SUMMARY OF VARIOUS ASPECTS OF THE DISCLOSURE

Methods for preventing, treating and/or controlling a causal agent of sheath blight in rice are provided. The methods involve applying an effective amount of benzobicyclon and/or benzobicyclon hydrolysate to a rice seed, a rice plant, or a field of rice plants comprising, or susceptible to, sheath blight. The method may further comprise selecting a rice plant, or a field of rice plants comprising, or susceptible to sheath blight before applying said effective amount of the benzobicyclon and/or benzobicyclon hydrolysate. The effective amount of benzobicyclon and/or benzobicyclon hydrolysate may be applied pre- or post-flood in a rice field.

Methods for preventing, treating and/or controlling Rhizoctonia solani in an area comprising, or susceptible to, R. solani are also provided. The methods involve applying an effective amount of benzobicyclon and/or benzobicyclon hydrolysate to an area comprising, or susceptible to, R. solani.

In some aspects, the benzobicyclon and/or benzobicyclon hydrolysate is in liquid form. In other aspects, the benzobicyclon and/or benzobicyclon hydrolysate is in solid form (e.g., granule, water dispersible granule, fertilizer granule coated with benzobicyclon and/or benzobicyclon hydrolysate) or powder form.

In other aspects of the methods described herein, one or more active ingredients are used with the benzobicyclon and/or benzobicyclon hydrolysate. In some aspects, the one or more active ingredients are acetolactate synthase (ALS) inhibitors such as sulfonylureas (e.g., halosulfuron-methyl), and may be used together with the benzobicyclon and/or benzobicyclon hydrolysate (e.g., as a single coated granule). In other aspects, the one or more active ingredients include, but are not limited to, fungicides such as azoxystrobin, trifloxystrobin, propiconazole, difenconazole, fluxapyroxad, flutolanil, and/or inpyrfluxam. These one or more active ingredients may be applied after benzobicyclon and/or benzobicyclon hydrolysate is applied (e.g., as part of a treatment regimen).

### BRIEF DESCRIPTION OF FIGURES

FIG. 1 shows the results of the experiment described in Example 1.

FIG. 2 shows the effect of various active agents on disease severity as described in Example 2.

FIG. 3 shows the effect of various active agents on disease incidence as described in Example 2.

FIG. 4 shows statistical analysis related to the effect of various active agents on disease incidence as described in Example 2.

FIG. 5 shows the effect of various active agents on disease index as described in Example 2.

FIG. 6 shows statistical analysis related to the effect of various active agents on disease index as described in Example 2.

FIG. 7 shows the effect of ROGUE® SC on incidence index as described in Example 3.

FIG. 8 shows the effect of ROGUE® SC on severity index as described in Example 3.

### DETAILED DESCRIPTION OF VARIOUS ASPECTS

Methods for preventing, treating and/or controlling a causal agent of sheath blight in rice are provided. The methods generally involve applying an effective amount of benzobicyclon and/or benzobicyclon hydrolysate to a rice seed, a rice plant, or a field of rice plants comprising, or susceptible to, sheath blight.

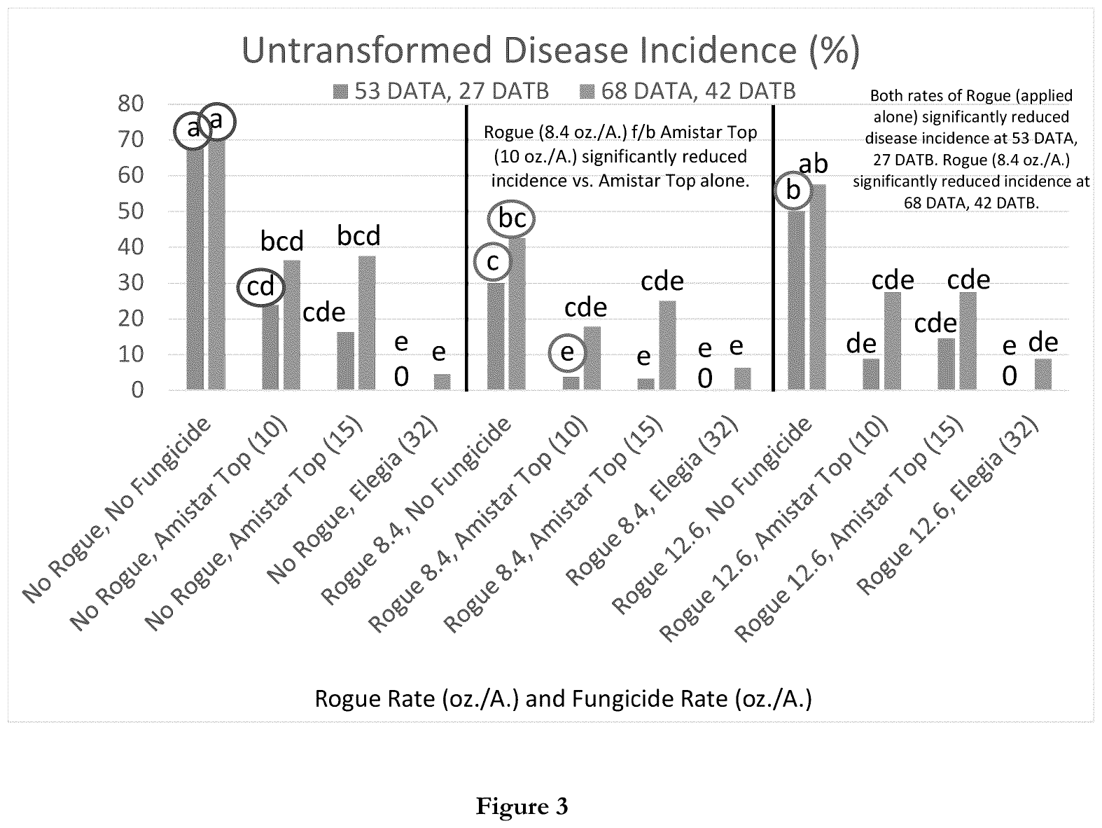

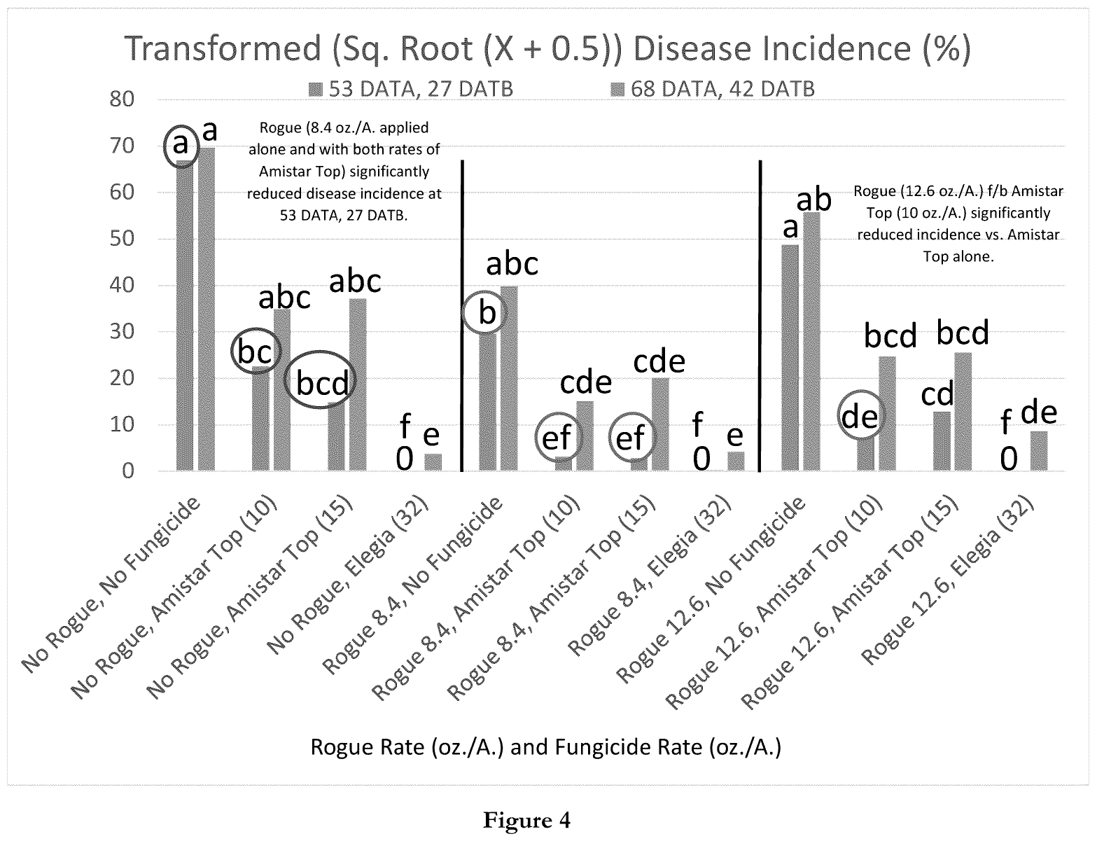

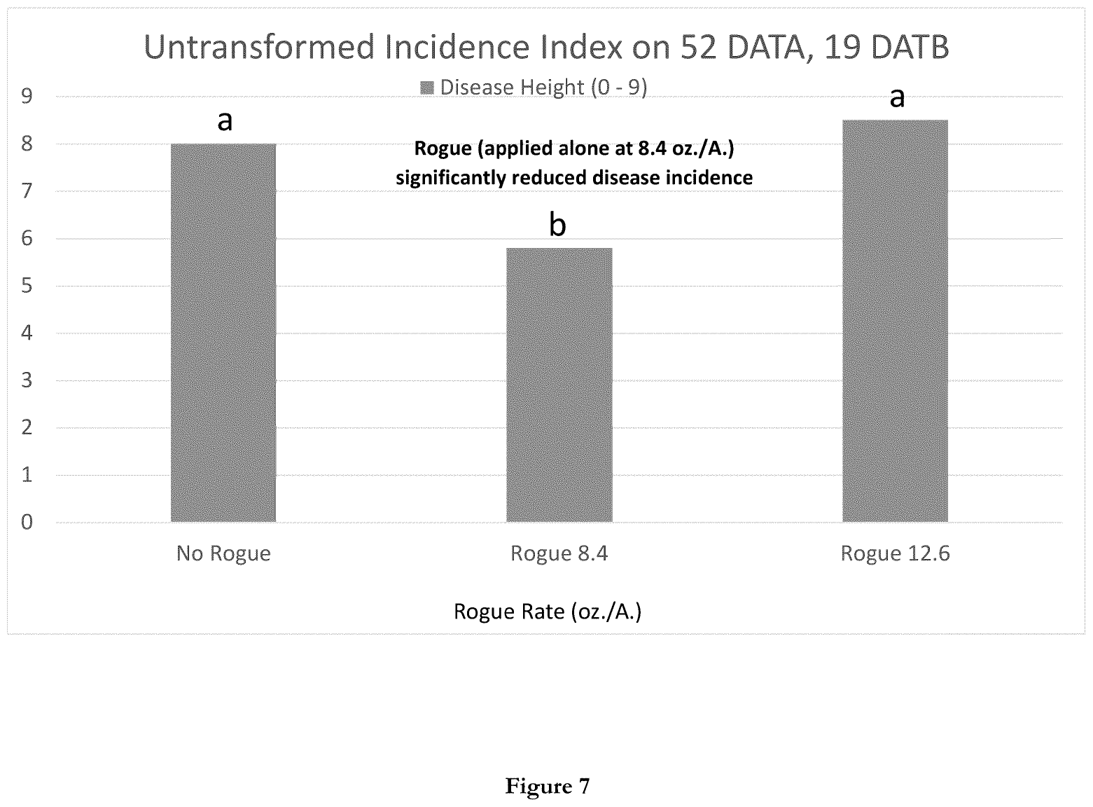

The inventor has surprisingly found that benzobicyclon and/or benzobicyclon hydrolysate (1) reduce disease incidence and/or severity of sheath blight in rice; and (2) can delay the need for application of sheath blight fungicide programs and/or complement fungicide programs for sheath blight. Specifically, in field trials, benzobicyclon and/or benzobicyclon hydrolysate was shown to reduce disease incidence of sheath blight (e.g., Example 2, FIG. 3), reduce disease incidence index of sheath blight (e.g., Example 3, FIG. 7), and enhanced suppression of sheath blight when used with other fungicides (e.g., Example 2, FIGS. 3 and 4).

The causal agent of sheath blight is Rhizoctonia solani. R. solani can infect rice from the seedling stage to harvest maturity, but sheath blight typically develops after tillering. R. solani generally appears as a small seed like structures called sclerotia or as mycelium in infected plant debris. This material floats when the rice is flooded and comes in contact with the rice plants. The initial infection occurs on the stem near the water line and appears as a lesion that often dries and turns tan. Additional lesions are visible and vary in appearance due to wetness, age, plant host resistance, and fungicide use.

In some aspects, the method comprises selecting a rice plant, or a field of rice plants comprising, or susceptible to sheath blight before applying said effective amount of benzobicyclon and/or benzobicyclon hydrolysate. The step may be performed using a visual inspection of the area and/or by physical testing.

In some aspects, benzobicyclon and/or benzobicyclon hydrolysate may be applied any time prior to infection of R. solani. In other aspects, benzobicyclon and/or benzobicyclon hydrolysate is applied pre-flood, post-flood, before and/or after permanent flood establishment in a rice field. In some aspects, benzobicyclon and/or benzobicyclon hydrolysate is applied within 1, 2, 3, 4, 5, 6, 7, 8, 9, 10, 15, 20, 25, 30, 35, 40, 45, 50, or more days within permanent flood establishment in a rice field. In other aspects, benzobicyclon and/or benzobicyclon hydrolysate is applied before harvest of rice. In any of the aspects described herein, benzobicyclon and/or benzobicyclon hydrolysate may be applied using a spray or broadcast application.

In some aspects, the benzobicyclon and/or benzobicyclon hydrolysate is in liquid form, solid form (e.g., granule, water dispersible granule, fertilizer granule coated with benzobicyclon and/or benzobicyclon hydrolysate), or powder form.

In other aspects, one or more acetolactate synthase (ALS) inhibitors are used together with the benzobicyclon and/or benzobicyclon hydrolysate. Exemplary ALS inhibitors include, but are not limited to, imidazolinones, pyrimidinylthiobenzoates, sulfonylaminocarbonyltriazolinone, sulfonylureas, and/or triazolopyrimidines. In particular aspects, benzobicyclon and/or benzobicyclon hydrolysate is used with one or more sulfonylureas such as halosulfuron-methyl, mesosulfuron-methyl, and/or metsulfuron-methyl prosulfuron (e.g., in a granule form such as a fertilizer coated with benzobicyclon and/or benzobicyclon hydrolysate and one or more ALS inhibitors described herein or coated with a liquid composition described in the following paragraphs).

In particular aspects, benzobicyclon is applied as a formulated liquid composition such as ROGUE® SC (35.4% benzobicyclon by weight of the composition, and 64.6% of other ingredients by weight of the composition). In some aspects, the liquid composition may be applied rate of 8.4-12.6 oz./acre or 100-150 grams/acre. In other aspects, the liquid composition may be applied at any of the rates described in the Examples below.

In other aspects, benzobicyclon and/or benzobicyclon hydrolysate is applied at a rate of 2-20 oz./acre, 3-18 oz./acre, 4-16 oz./acre, 5-15 oz./acre, 6-14 oz./acre, or 7-13 oz./acre (or any integer between 2-20). In other aspects, benzobicyclon and/or benzobicyclon hydrolysate is applied at a rate of 50-200 grams/acre, 75-175 grams/acre, or 100-150 grams/acre (or any integer between 50-200).

In particular aspects, benzobicyclon is applied as a formulated granular composition such as BUTTER (3% benzobicyclon by weight of the composition, 0.64% halosulfuron-methyl by weight of the composition, and 96.36% of other ingredients by weight of the composition). In other aspects, the granular composition is applied at a rate of 7.5-9.0 lb per acre, 6.0-10.0 per acre, or 7.0-9.5 lb per acre.

In other aspects, one or more active ingredients are used with benzobicyclon and/or benzobicyclon hydrolysate in a treatment regimen. In some aspects, the one or more active ingredients are one or more fungicides that prevent, treat and/or control sheath blight in rice. In some aspects, the one or more active ingredients include, but are not limited to, azoxystrobin, trifloxystrobin, propiconazole, difenconazole, fluxapyroxad, flutolanil, and/or inpyrfluxam. The one or more active ingredients may be applied at any time before and/or after benzobicyclon and/or benzobicyclon hydrolysate is applied. In some aspects, the one or more active ingredients are applied 1, 2, 3, 4, 5, 6, 7, 8, 9, 10, 11, 12, 13, 14, 15, 16, 17, 18, 19, 20, 21, 25, or more days before and/or after applying benzobicyclon and/or benzobicyclon hydrolysate.

In some aspects, the rice plant is highly susceptible, susceptible or moderately susceptible to sheath blight. Those with skill in the art evaluate susceptibility based on a 0-9 or 0-100% scales to determine whether a cultivar is highly susceptible, susceptible, moderately susceptible, moderately, resistant or highly resistant (see Table 1 below).

TABLE 1
Evaluation of Susceptibility to Sheath Blight

| Infection (%) | Score | Host Response |
|---|---|---|
| No infection observed | 0 | Highly Resistant |
| Lesions limited to below 20% | 1 | Resistant |
| of the plant height | | |
| 21-30% | 3 | Moderately Resistant |
| 31-45% | 5 | Moderately Susceptible |
| 46-65% | 7 | Susceptible |
| More than 65% | 9 | Highly/Very Susceptible |

Examples of rice cultivars that are highly/very susceptible, susceptible or moderately susceptible to sheath blight are provided in Table 2 below.

TABLE 2
Susceptibility of Exemplary Rice Cultivars to Sheath Blight

| Cultivar | Susceptibility of Sheath Blight |
|---|---|
| ARoma 17 | MS |
| CL111 | VS |
| CL151 | S |
| CL153 | S |
| CL163 | S |
| CLL15 | S |
| CLL16 | S |
| CLL17 | S |
| CLM04 | MS |
| Della-2 | S |
| DG263L | S |
| Diamond | S |
| Jazzman-2 | S |
| Jewel | MS |
| Jupiter | S |
| LaKast | MS |
| Lynx | S |
| ProGold1 | S |
| ProGold2 | MS |
| PVL02 | S |
| Roy J | MS |
| RT 7301 | MS |
| RT 7321 FP | MS |
| RT 7401 | MS |
| RT 7501 | S |
| RT 7521 FP | S |
| RT 7801 | MS |
| RT CL XL745 | S |
| RT Gemini 214 CL | S |
| RT XP753 | MS |
| Titan | S |

MS = Moderately Susceptible; S = Susceptible; VS = Highly/Very Susceptible.¹

In some aspects, benzobicyclon and/or benzobicyclon hydrolysate, and/or one or more active ingredients may be applied with one or more agriculturally acceptable adjuvants. In some aspects, the agriculturally acceptable adjuvants may include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof. In particular aspects, the agriculturally acceptable adjuvant is a methylated seed oil (MSO) and/or MSO blends. In other aspects, the MSO and/or MSO blends are included at a 1% v/v concentration (1 gal per 100 gal of spray solution). ¹See Wamishe et al., “Reactions of Arkansas Rice Cultivars to Major Diseases in 2020,” Nov. 4, 2020 (available at on the world wide web at ricefarming.com/departments/breaking-news/reactions-of-arkansas-rice-cultivars-to-major-diseases-in-2020/).

In other aspects, methods for preventing, treating and/or controlling Rhizoctonia solani in an area comprising, or susceptible to, R. solani are also provided. The methods involve applying an effective amount of benzobicyclon and/or benzobicyclon hydrolysate to an area comprising, or susceptible to, R. solani.

In some aspects, the method comprises selecting an area comprising, or susceptible to R. solani before applying said effective amount of benzobicyclon and/or benzobicyclon hydrolysate. The step may be performed using a visual inspection of the area and/or by physical testing.

In other aspects, benzobicyclon and/or benzobicyclon hydrolysate may be applied using a spray or broadcast application.

In other aspects, one or more active ingredients are used with benzobicyclon and/or benzobicyclon hydrolysate in a treatment regimen. In some aspects, the one or more active ingredients are one or more fungicides that prevent, treat and/or control R. solani. In some aspects, the one or more active ingredients include, but are not limited to, azoxystrobin, trifloxystrobin, propiconazole, difenconazole, fluxapyroxad, flutolanil, and/or inpyrfluxam. The one or more active ingredients may be applied at any time before and/or after benzobicyclon and/or benzobicyclon hydrolysate is applied. In some aspects, the one or more active ingredients are applied 1, 2, 3, 4, 5, 6, 7, 8, 9, 10, 11, 12, 13, 14, 15, 16, 17, 18, 19, 20, 21, 25, or more days before and/or after applying benzobicyclon and/or benzobicyclon hydrolysate.

Various aspects will now be particularly described by way of examples. The following descriptions of specific aspects are presented for purposes of illustration and description. They are not intended to be exhaustive of or to limit the disclosure.

### EXAMPLES

### Example 1-Greenhouse Study

A greenhouse study was performed with flooded rice grown in pots. ROGUE® SC herbicide (benzobicyclon:-3-[2-chloro-4-(methylsulfonyl)benzoyl]-4-(phenylthio) bicyclo-[3.2.1]oct-3-en-2-one) was applied via pipette at two rates (12.6 and 25.2 oz./A.) in diluted form to the water surface in each pot of rice (10 plants/pot/three pots). Immediately after the ROGUE® SC application, a collar (dissected 2 liter bottle) was placed around the plants in each pot to focus the inoculum in the area of the rice stems. An untreated check (10 plants/pot/three pots) was also prepared. A highly infectious mix of two naturally occurring isolates of Rhizoctonia solani on oat grains was applied to the inside of the collar region in each pot at the equivalent inoculum rate used in field trials. Immediately following inoculation, a translucent plastic bag was placed over each pot to maintain a high degree of humidity to enhance the establishment of the sclerotia on the rice shoots. At 12 days after treatment (DAT), the bags were removed and each plant in each of the three replications were evaluated for severity of R. solani infection. There were 8-10 subsamples for each of three replications for each treatment.

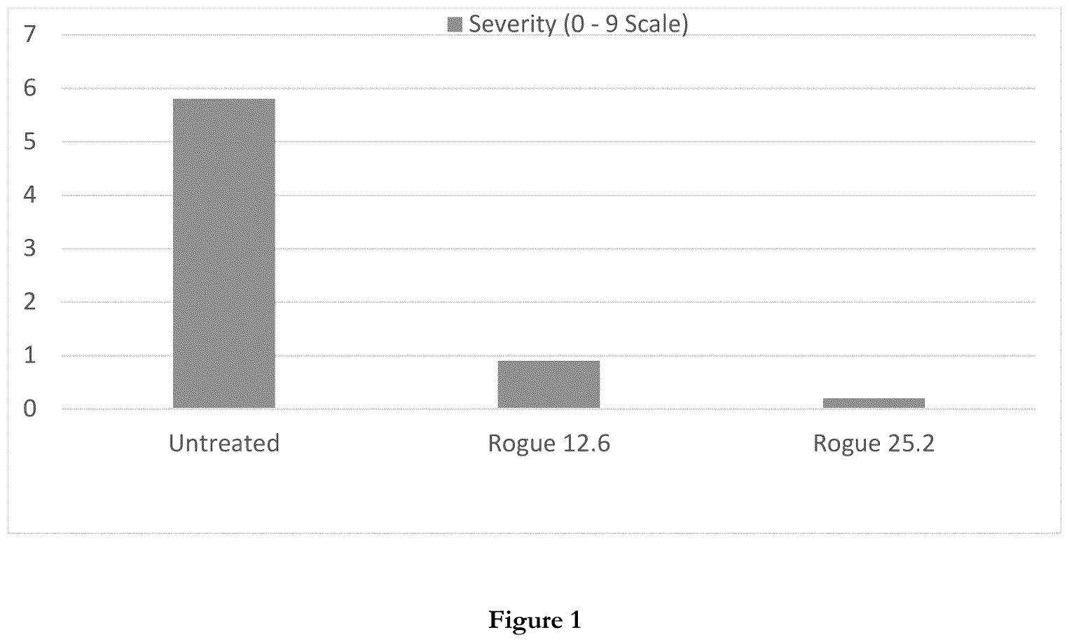

At 12 DAT, one of the three replications of the untreated check had no infection of R. solani and was therefore omitted from the analysis of the data. The untreated check exhibited a high degree of severity (5.8 on a scale of 0-9). Both rates of ROGUE® SC resulted in a significant reduction in infection severity, with no significant difference noted between the two rates of ROGUE® SC. The results are shown in FIG. 1.

### Example 2-Field Test (Arkansas)

A field trial was run to evaluate ROGUE® SC herbicide for preventative control of sheath blight on rice, and to determine whether ROGUE® SC can delay the need for application of sheath blight fungicide programs or complement fungicide programs for sheath blight.

The trial consisted of three bays. The first bay had no ROGUE® SC but included a check (inoculated) and the three fungicide programs (Treatments 1-4). The second bay had ROGUE® SC (rate of 8.4 oz./A.) applied to the whole bay with an untreated check (inoculated, ROGUER SC treated but no fungicide) and the three fungicide programs (Treatments 5-8). The third bay had ROGUE® SC (rate of 12.6 oz./A.) applied to the whole bay with an untreated check (inoculated, ROGUE® SC treated but no fungicide) and the three fungicide programs (Treatments 9-12).

CL163 rice was planted at 104 lb./A. on Apr. 28, 2022, emergence occurred on May 7, 2022. ROGUE® SC was applied in 10 gal./A. on Jun. 10, 2022 (Appl. A), inoculum (454 g./plot) was applied on Jul. 1, 2022 (21 DATA), and the fungicides were applied in 20 gal./A. on Jul. 6, 2022 (Appl. B). ROGUE® SC was applied with Methylated Seed Oil (MSO) at 1% v/v. The fungicides were AMISTAR® Top (azoxystrobin, difenoconazole) and ELEGIA® (flutolanil).

The treatment protocol is provided below.

| Trt | | Treatment | Form | Form | Form | | Rate | Other | Other |
|---|---|---|---|---|---|---|---|---|---|
| No. | Type | Name | Conc | Unit | Type | Rate | Unit | Rate | Rate Unit |
| 1 | HERB | No Rogue | | | | | | | |
| | CHK | Untreated Check | | | | | | | |
| 2 | HERB | No Rogue | 2.72 | LBA/GAL | SC | 0.73 | L/ha | 10 | OZ/A |
| | FUNG | Amistar Top | | | | | | | |
| 3 | HERB | No Rogue | 2.72 | LBA/GAL | SC | 1.1 | L/ha | 15 | OZ/A |
| | FUNG | Amistar Top | | | | | | | |
| 4 | HERB | No Rogue | | | | | | | |
| | FUNG | Elegia | 3.8 | LBA/GAL | SC | 2.33 | L/ha | 32.0 | OZ/A |
| 5 | HERB | Rogue | 400 | gA/L | SC | 246 | g AI/ha | 8.4 | OZ/A |
| | ADJ | MSO | 100 | % | L | 1.0 | % V/V | 25.6 | OZ/A |
| | CHK | Untreated Check | | | | | | | |
| 6 | HERB | Rogue | 400 | gA/L | SC | 246 | g AI/ha | 8.4 | OZ/A |
| | ADJ | MSO | 100 | 0% | L | 1.0 | % V/V | 25.6 | OZ/A |
| | FUNG | Amistar Top | 2.72 | LBA/GAL | SC | 0.73 | L/ha | 10 | OZ/A |
| 7 | HERB | Rogue | 400 | gA/L | SC | 246 | g AI/ha | 8.4 | OZ/A |
| | ADJ | MSO | 100 | 0% | L | 1.0 | % V/V | 25.6 | OZ/A |
| | FUNG | Amistar Top | 2.72 | LBA/GAL | SC | 1.1 | L/ha | 15 | OZ/A |
| 8 | HERB | Rogue | 400 | gA/L | SC | 246 | g AI/ha | 8.4 | OZ/A |
| | ADJ | MSO | 100 | % | L | 1.0 | % V/V | 25.6 | OZ/A |
| | FUNG | Elegia | [symbol] | [symbol] | [symbol] | [symbol] | [symbol] | [symbol] | [symbol] |
| 9 | HERB | Rogue | 400 | gA/L | SC | 370 | g AI/ha | 12.6 | OZ/A |
| | ADJ | MSO | 100 | % | L | 1.0 | % V/V | 25.6 | OZ/A |
| | CHK | Untreated Check | | | | | | | |
| 10 | HERB | Rogue | 400 | gA/L | SC | 370 | g AI/ha | 12.6 | OZ/A |
| | ADJ | MSO | 100 | % | L | 1.0 | % V/V | 25.6 | OZ/A |
| | FUNG | Amistar Top | 2.72 | LBA/GAL | SC | 0.73 | L/ha | 10 | OZ/A |
| 11 | HERB | Rogue | 400 | gA/L | SC | 370 | g AI/ha | 12.6 | OZ/A |
| | ADJ | MSO | 100 | 0% | L | 1.0 | % V/V | 25.6 | OZ/A |
| | FUNG | Amistar Top | 2.72 | LBA/GAL | SC | 1.1 | L/ha | 15 | OZ/A |
| 12 | HERB | Rogue | 400 | gA/L | SC | 370 | g AI/ha | 12.6 | OZ/A |
| | ADJ | MSO | 100 | 0% | L | 1.0 | % V/V | 25.6 | OZ/A |
| | FUNG | Elegia | [symbol] | [symbol] | [symbol] | [symbol] | [symbol] | [symbol] | [symbol] |

| Trt | | Appl | Appl | Appl | Appl | Amount |
|---|---|---|---|---|---|---|
| No. | Type | Timing | Code | Description | Amount | Unit |
| 1 | HERB | | | | | |
| | CHK | | | | | |
| 2 | HERB | POEMCR | B | Sheath blight threshold | 20 | GAL/AC |
| | FUNG | | | | | |
| 3 | HERB | POEMCR | B | Sheath blight threshold | 20 | GAL/AC |
| | FUNG | | | | | |
| 4 | HERB | | | | | |
| | FUNG | POEMCR | B | Sheath blight threshold | 20 | GAL/AC |
| 5 | HERB | POEMCR | A | Post-flood within 7 days | 20 | GAL/AC |
| | ADJ | POEMCR | A | Post-flood within 7 days | 20 | GAL/AC |
| | CHK | | | | | |
| 6 | HERB | POEMCR | A | Post-flood within 7 days | 20 | GAL/AC |
| | ADJ | POEMCR | A | Post-flood within 7 days | 20 | GAL/AC |
| | FUNG | POEMCR | B | Sheath blight threshold | 20 | GAL/AC |
| 7 | HERB | POEMCR | A | Post-flood within 7 days | 20 | GAL/AC |
| | ADJ | POEMCR | A | Post-flood within 7 days | 20 | GAL/AC |
| | FUNG | POEMCR | B | Sheath blight threshold | 20 | GAL/AC |
| 8 | HERB | POEMCR | A | Post-flood within 7 days | 20 | GAL/AC |
| | ADJ | POEMCR | A | Post-flood within 7 days | 20 | GAL/AC |
| | FUNG | [symbol] | [symbol] | [symbol] | [symbol] | GAL/AC |
| 9 | HERB | POEMCR | A | Post-flood within 7 days | 20 | GAL/AC |
| | ADJ | POEMCR | A | Post-flood within 7 days | 20 | GAL/AC |
| | CHK | | | | | |
| 10 | HERB | POEMCR | A | Post-flood within 7 days | 20 | GAL/AC |
| | ADJ | POEMCR | A | Post-flood within 7 days | 20 | GAL/AC |
| | FUNG | POEMCR | B | Sheath blight threshold | 20 | GAL/AC |
| 11 | HERB | POEMCR | A | Post-flood within 7 days | 20 | GAL/AC |
| | ADJ | POEMCR | A | Post-flood within 7 days | 20 | GAL/AC |
| | FUNG | POEMCR | B | Sheath blight threshold | 20 | GAL/AC |
| 12 | HERB | POEMCR | A | Post-flood within 7 days | 20 | GAL/AC |
| | ADJ | POEMCR | A | Post-flood within 7 days | 20 | GAL/AC |
| | FUNG | [symbol] | [symbol] | [symbol] | [symbol] | GAL/AC |

Replications: 3, Untreated treatments: 13, Design: Completely Random (CRD), Treatment units: Treated ‘Plot’ experimental unit size, Dry Form. Unit: %, Treated ‘Plot’ experimental unit size Width: 5 feet, Treated ‘Plot’ experimental unit size Length: 15 feet, Application amount: 20 GAL/AC, Mix size: 1 L, Format definitions: G-All7.def, G-All7.frm [symbol]
indicates data missing or illegible when filed

Each replication was evaluated at three locations in each plot, avoiding edge effects on the ends and sides of each plot. The canopy was opened using a 1 meter stick so that the following parameters could be evaluated at each of the three locations in each plot, and an average determined for that plot. Evaluation parameters included severity, incidence, and disease index. Severity is a measure of how high up the plant the disease has moved on the plants in that 1 meter area, with “8” indicating infection of the flag leaf (the leaf that feeds the grain in the panicle), and “9” indicating infection of the entire plant. Incidence is a measure of plant-to-plant (or leaf-to-leaf) transmission and is expressed as a percentage of the plants in that 1 meter row infected with sheath blight. Disease index is a measure of the overall disease and combines severity and incidence for an overall measure of disease. The formula is:

$$\frac{Severity ( 0 - 9 ) \times Incidence ( \% )}{100}$$

### Results

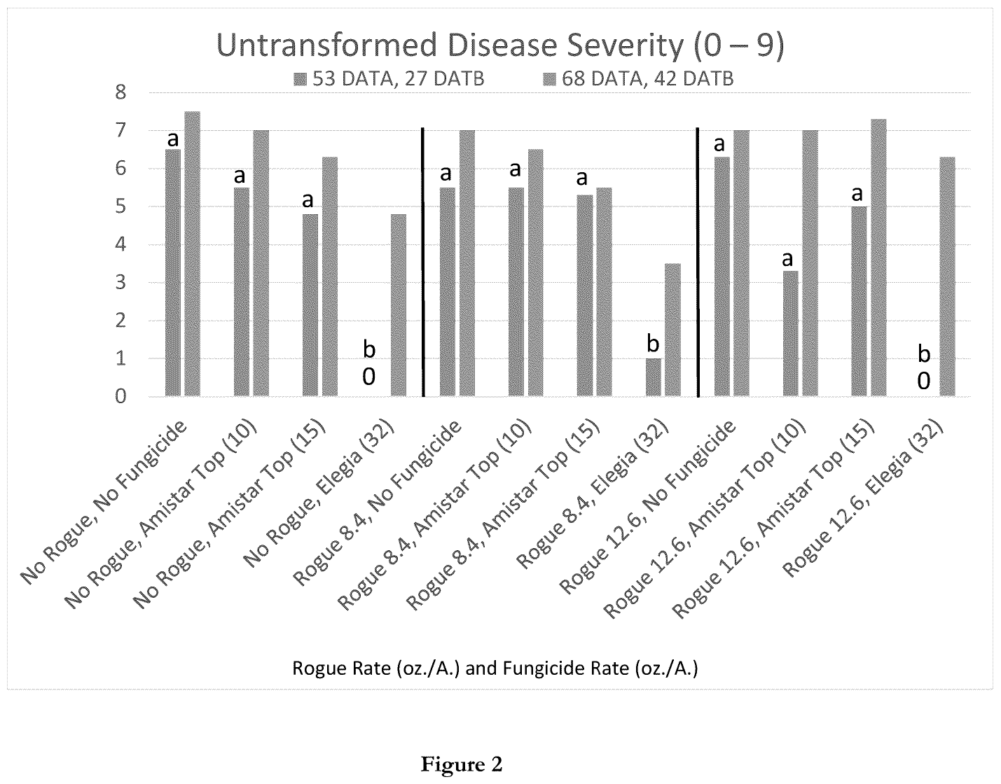

FIG. 2 shows the effect on disease severity. The eight left bars represent the treatments that did not include ROGUE® SC, the eight center bars represent treatments that included the low rate of ROGUE® SC (8.4 oz./A.), and the eight right bars represent treatments that included the high rate of ROGUE® SC (12.6 oz./A.). At the first evaluation (53 days after ROGUE® SC application (A) and 27 days after the fungicide application (B)), ELEGIA® exhibited a significant reduction in disease severity when compared with the untreated check and the two rates of AMISTAR® Top, with no effect of ROGUE® SC noted. The two AMISTAR® Top treatments reduced disease severity but were not significantly lower than the untreated check. No effect of ROGUE® SC on disease severity was noted with AMISTAR® Top treatments. At the last evaluation (68 days after ROGUE® SC application (A) and 42 days after the fungicide application (B)), disease severity in the untreated check had increased and no significant differences were noted among treatments.

FIG. 3 shows the effect on disease incidence. At the first evaluation (53 days after ROGUE® SC application (A) and 27 days after the fungicide application (B)), both rates of ROGUE® SC exhibited a significant reduction in disease incidence when compared with the untreated check. In contrast to what was seen relative to disease severity, all fungicide treatments significantly reduced disease incidence when compared with the untreated check, with ELEGIA® exhibiting 0 incidence. When the low rate of AMISTAR® Top was combined with the low rate of ROGUE® SC, a significant reduction in incidence was noted versus the low rate of AMISTAR® Top applied alone. When the high rate of AMISTAR® Top was combined with either rate of ROGUE® SC, a reduction in incidence was noted but was not statistically significant. At the second evaluation (68 days after ROGUE® SC application (A) and 42 days after the fungicide application (B)), the low rate of ROGUE® SC exhibited a significant reduction in disease incidence when compared with the untreated check. The high rate of ROGUE® SC exhibited a reduction in disease incidence, but the reduction was not statistically different from the untreated. When both rates of AMISTAR® Top were combined with either rate of ROGUE® SC, a reduction in incidence was noted but was not statistically different from the untreated. ROGUE® SC did not exhibit an effect on disease incidence when combined with ELEGIA®, due to the efficacy of ELEGIA® applied alone.

FIG. 4 shows the results of a statistical analysis of disease incidence data due to lack of uniformity. A square root (X+0.5) transformation was applied to the data and reanalyzed. At the first evaluation (53 days after ROGUE® SC application (A) and 27 days after the fungicide application (B)), the low rate of ROGUE® SC exhibited a significant reduction in disease incidence when compared with the untreated check. The high rate of ROGUE® SC exhibited a reduction in incidence but was not statistically different from the untreated check. All fungicide treatments significantly reduced disease incidence when compared with the untreated check, with ELEGIA® exhibiting no incidence. When both rates of AMISTAR® Top were combined with the low rate of Rogue, a significant reduction in incidence was noted versus AMISTAR® Top applied alone. When the low rate of AMISTAR® Top was combined with the high rate of ROGUE® SC, a significant reduction in incidence was noted. When the high rate of AMISTAR® Top was combined with the high rate of Rogue, a reduction in incidence was noted but was not statistically different from the high rate of AMISTAR® Top applied alone. At the second evaluation (68 days after ROGUE® SC application (A) and 42 days after the fungicide application (B)), both rates of ROGUE® SC exhibited a reduction in disease incidence when compared with the untreated check but were not statistically different from the untreated. When both rates of AMISTAR® Top were combined with either rate of Rogue, a reduction in incidence was noted but was not statistically significant. ROGUE® SC did not exhibit an effect on disease incidence when combined with ELEGIA®, due to the efficacy of ELEGIA® applied alone.

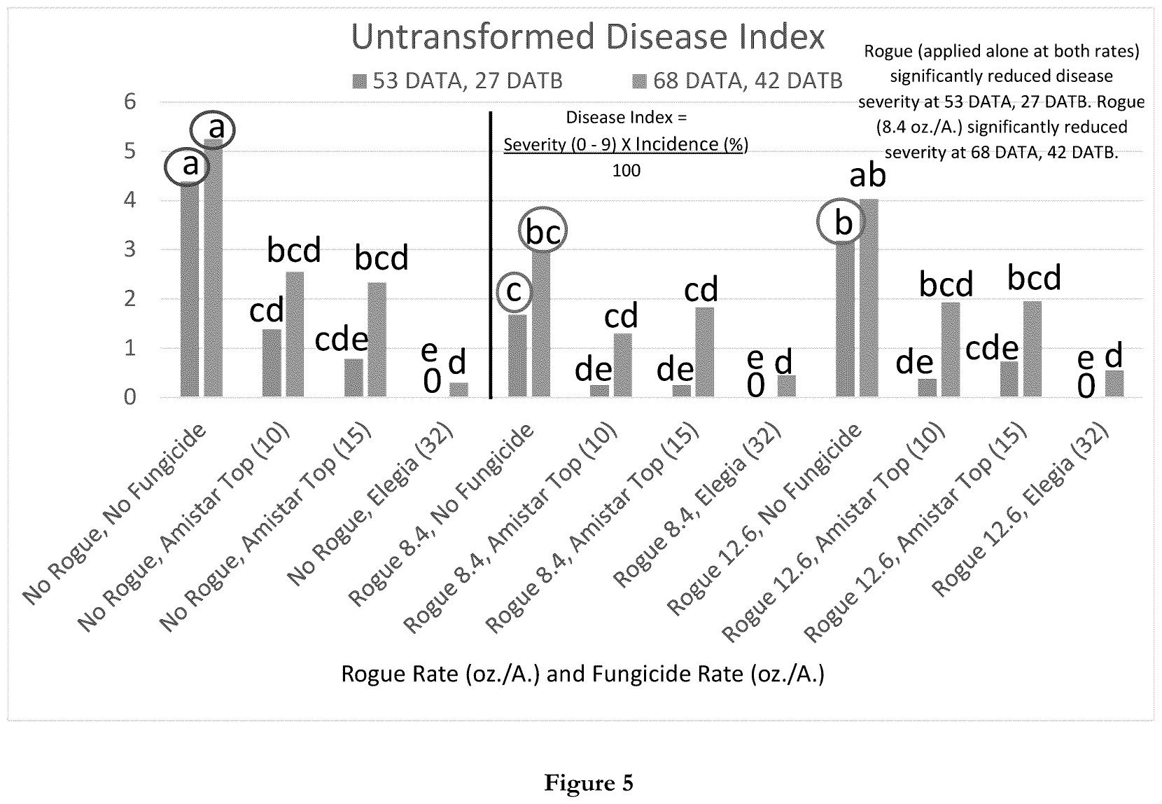

FIG. 5 shows the effect on disease index. When disease index was evaluated at 53 days after ROGUE® SC application (A) and 27 days after the fungicide application (B), both rates of ROGUE® exhibited a significant reduction in disease index when compared with the untreated check. All fungicide treatments significantly reduced disease index when compared with the untreated check, with ELEGIA® exhibiting an index of 0. When both rates of AMISTAR® Top were combined with either rate of ROGUE®, a reduction in index was noted but was not statistically different from AMISTAR® Top applied alone. At the second evaluation (68 days after ROGUE® SC application (A) and 42 days after the fungicide application (B)), the low rate of ROGUE® SC exhibited a significant reduction in disease index when compared with the untreated check. The high rate of ROGUE® exhibited a reduction in disease index, but the reduction was not statistically different from the untreated. When both rates of AMISTAR® Top were combined with either rate of ROGUE® SC, a reduction in index was noted but was not statistically different from AMISTAR® Top applied alone. ROGUE® SC did not exhibit an effect on disease index when combined with ELEGIA®, due to the efficacy of ELEGIA® applied alone.

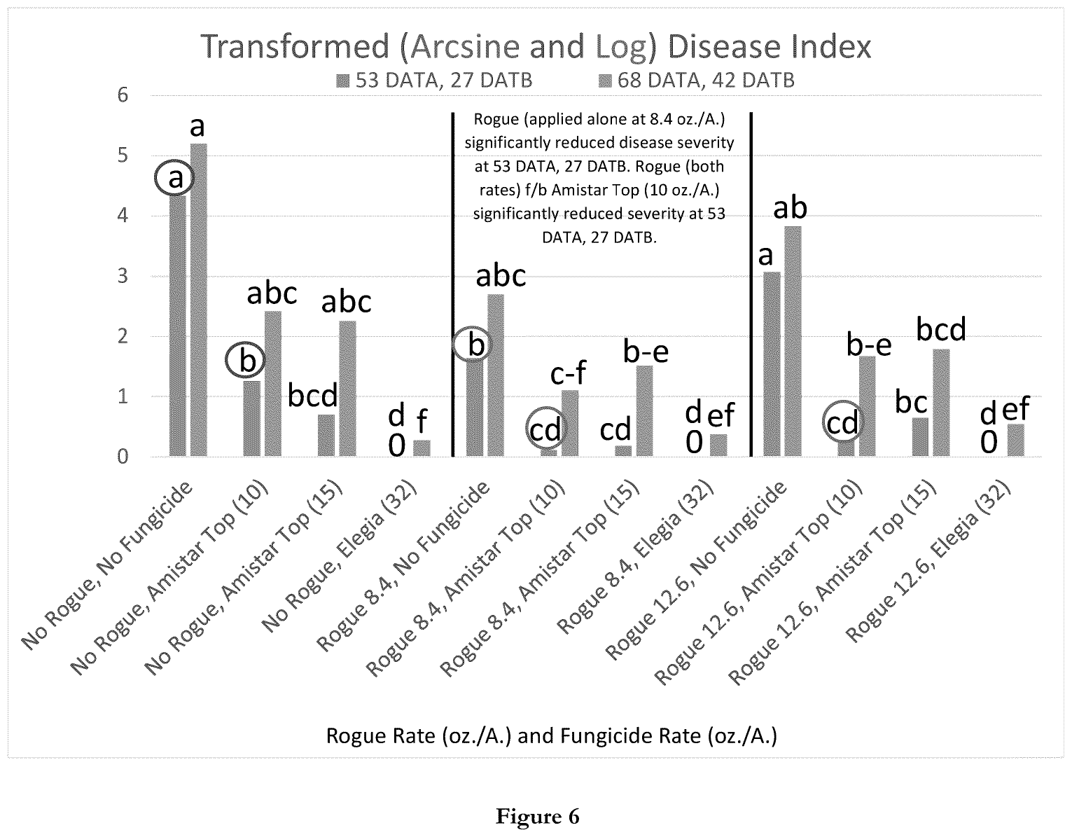

Statistical analysis of disease index is shown in FIG. 6. Statistical analysis of the disease index data indicated that a transformation should be applied to the data due to lack of uniformity. An arcsine square root transformation was applied to the data at 53 DATA and 27 DATB; a log transformation was applied to the data at 68 DATA and 42 DATB. Disease index data was then reanalyzed. At the first evaluation (53 days after ROGUE® application (A) and 27 days after the fungicide application (B)), the low rate of ROGUE® exhibited a significant reduction in disease index when compared with the untreated check. All fungicide treatments significantly reduced disease index when compared with the untreated check, with ELEGIA® exhibiting an index of 0. When the low rate of AMISTAR® Top was combined with both rates of Rogue, a significant reduction in index was noted versus the low rate of AMISTAR® Top applied alone. At the second evaluation (68 days after ROGUE® application (A) and 42 days after the fungicide application (B)), both rates of ROGUE® exhibited a reduction in disease index when compared with the untreated check, but the difference was not statistically significant. The high rate of ROGUE® exhibited a reduction in disease index, but the reduction was not statistically significant. When both rates of AMISTAR® Top were combined with either rate of ROGUE®, a reduction in index was noted but was not statistically significant. ROGUE® SC did not exhibit an effect on disease index when combined with ELEGIA®, due to the efficacy of ELEGIA® applied alone.

### Conclusions

No rice phytotoxicity noted at 33 DATA and 7 DATB. The growing season was hot and dry and sheath blight disease progress slowed down particularly during the early stages of the trial.

ROGUE® SC had minimal effect against sheath blight severity (primary infection). When applied alone, both rates of ROGUE® SC (8.4 and 12.6 oz./A.), resulted in significant reduction in disease incidence (percentage of plants exhibiting sheath blight) when compared with the untreated check at 53 DATA and 27 DATB (FIG. 3). Applied alone, ROGUE® SC (8.4 oz./A.) significantly reduced disease incidence at 68 DATA and 42 DATB.

Applied alone, ROGUE® SC lowered sheath blight disease progress (leaf to leaf transmission). ROGUE® SC (8.4 oz./A.) followed by AMISTAR® Top (10 oz./A.) significantly reduced disease incidence at 53 DATA and 27 DATB when compared with AMISTAR® Top applied alone. Due to heterogeneity of variance/skewness, a square root (X+0.5) transformation was applied to the data for disease incidence (FIG. 4). ROGUE® SC (8.4 oz./A.) applied alone or followed by both rates of AMISTAR® Top, exhibited significantly reduced disease incidence at 53 DATA and 27 DATB. When ROGUE® SC (12.6 oz./A.) was followed by AMISTAR® Top (10 oz./A.), significantly reduced disease incidence was exhibited at 53 DATA and 27 DATB when compared with AMISTAR® Top applied alone.

ROGUE® SC enhanced the suppression of sheath blight when using AMISTAR® Top at the lower rate (10 oz./A). When sheath blight severity index was evaluated, Rogue, applied alone at both rates, significantly reduced index at 53 DATA and 27 DATB when compared with the untreated check (FIG. 5). Applied alone, ROGUE® SC (8.4 oz./A.) significantly reduced severity index at 68 DATA and 42 DATB and was significantly better than the high rate of 12.6 oz./A.

ROGUE® SC (8.4 oz./A.) reduced the incidence of sheath blight and that resulted in a reduction in disease index. ANOVA indicated that data for disease index had heterogeneity of variance/skewness. An arcsine square root (X+0.5) transformation was applied to the 53 DATA and 42 DATB data, and a log transformation was applied to the 68 DATA and 42 DATB data (FIG. 6). Applied alone, ROGUE® SC (8.4 oz./A.) significantly reduced disease index at 53 DATA and 27 DATB. Both rates of Rogue, when followed by AMISTAR® Top (10 oz./A.), significantly reduced disease severity at 53 DATA and 27 DATB.

### Example 3-Field Test (Louisiana)

A field trial was run to evaluate ROGUE® SC herbicide for preventative control of sheath blight on rice.

The trial consisted of three bays. The first bay had no ROGUE® SC but included an inoculated check (Treatment 1). The second bay had ROGUE® SC (label rate of 8.4 oz./A.) applied to the whole bay with an untreated check which was inoculated and treated with ROGUE® SC (Treatment 2). The third bay had ROGUE® SC (label rate of 12.6 oz./A.) applied to the whole bay with an untreated check which was inoculated and treated with ROGUE® SC (Treatment 3).

CLL111 rice was planted at 60 lb./A. on Apr. 22, 2022, emergence occurred on May 3, 2022. ROGUE® SC was applied in 2 gal./A. via drone on Jun. 3, 2022 (Appl. A), inoculum was applied on Jun. 17, 2022 (14 DATA).

The treatment protocol is provided below.

| Trt | | Treatment | Form | Form | Form | | Rate | Other | Other | Appl | Appl | Appl | Appl | Amount |
|---|---|---|---|---|---|---|---|---|---|---|---|---|---|---|
| No. | Type | Name | Conc | Unit | Type | Rate | Unit | Rate | Rate Unit | Timing | Code | Description | Amount | Unit |
| 1 | HERB | No Rogue | | | | | | | | | | | | |
| 2 | HERB | Rogue | 400 | gA/L | SC | 246 | g AI/ha | 8.4 | OZ/A | POEMCR | A | Post-flood | 2 | GAL/AC |
| | | | | | | | | | | | | within 7 days | | |
| | ADJ | MSO | 100 | % | L | 1.0 | % V/V | 25.6 | OZ/A | POEMCR | A | Post-flood | 2 | GAL/AC |
| | | | | | | | | | | | | within 7 days | | |
| 3 | HERB | Rogue | 400 | gA/L | SC | 370 | g AI/ha | 12.6 | OZ/A | POEMCR | A | Post-flood | 2 | GAL/AC |
| | | | | | | | | | | | | within 7 days | | |
| | ADJ | MSO | 100 | % | 0% | 1.0 | % V/V | 25.6 | OZ/A | POEMCR | A | Post-flood | 2 | GAL/AC |
| | | | | | | | | | | | | within 7 days | | |

Replications: 3, Untreated treatments: 13, Design: Completely Random (CRD), Treatment units: Treated ‘Plot’ experimental unit size, Dry Form. Unit: %, Treated ‘Plot’ experimental unit size Width: 6 feet, Treated ‘Plot’ experimental unit size Length: 25 feet, Application amount: 2 GAL/AC, Mix size: 1 L, Format definitions: G-All7.def, G-All7.frm

Each replication was evaluated at three locations in each plot, avoiding edge effects on the ends and sides of each plot. The canopy was opened using a 1 meter stick so that the following parameters could be evaluated at each of the three locations in each plot, and an average determined for that plot. In this trial, “incidence” indicates how high in the canopy the disease is progressing (0-9 scale, with “8” indicating disease on the flag leaf), and “severity” indicates spread of the disease in the canopy.

### CONCLUSIONS

No rice phytotoxicity was noted in the trial. On July 25 (52 DATA and 19 DATB), significant differences were noted among means for sheath blight disease incidence (height) when ROGUE® SC rates (0, 8.4 and 12.6 oz./A.) were compared (FIG. 7). Sheath blight in the untreated check progressed to the flag leaf. ROGUE® SC (8.4 oz./A.) exhibited significantly lower incidence (height of sheath blight symptomology on the plant) when compared with the untreated check while ROGUE® SC (12.6 oz./A.) exhibited disease incidence that was higher but not significantly different from the untreated check.

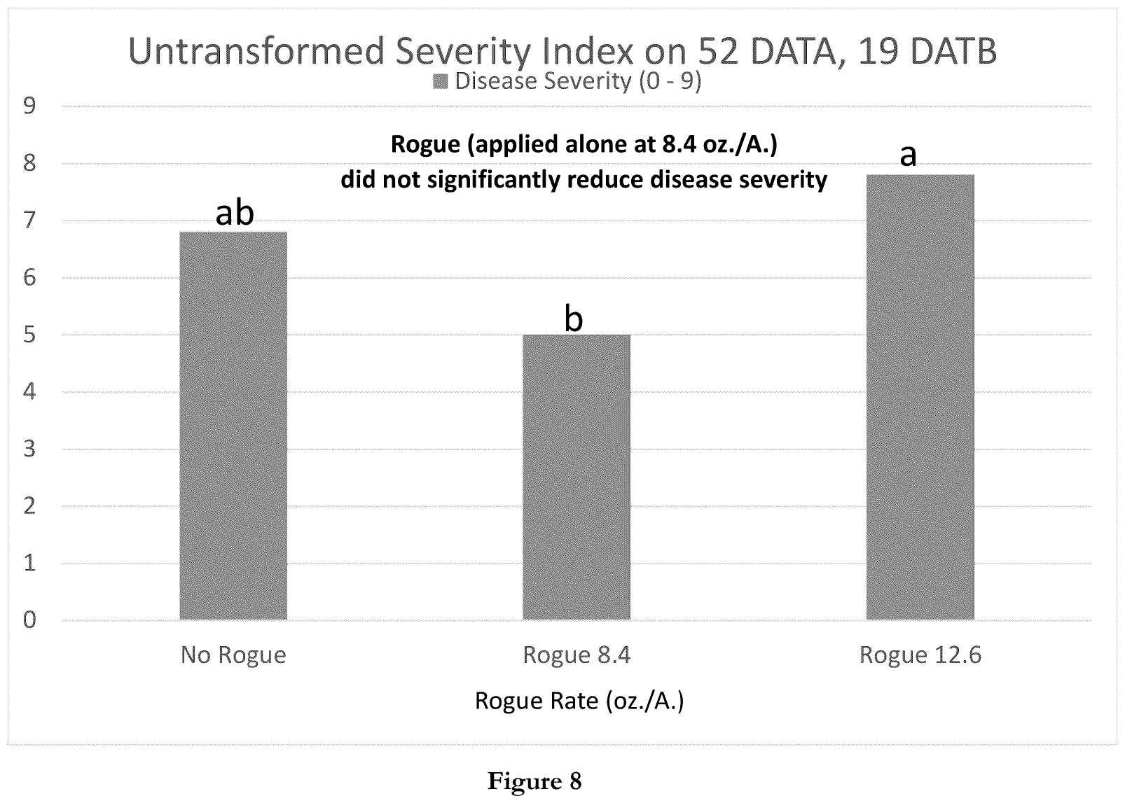

ROGUE® SC exhibited lower sheath blight disease progress and had a significant effect against sheath blight moving through the canopy. When sheath blight severity index was evaluated, ROGUE® SC (8.4 oz./A.) exhibited a severity index that was significantly lower than the high rate but was not significantly different from the untreated check (FIG. 8). ROGUE® SC (12.6 oz./A.) exhibited a severity index that was higher than the untreated check but was not significantly different. ROGUE® SC had no significant effect on sheath blight severity (area of the plant exhibiting symptomology).

1. A method for preventing, treating and/or controlling sheath blight in rice comprising applying an effective amount of benzobicyclon and/or benzobicyclon hydrolysate to a rice seed, a rice plant, or a field of rice plants comprising, or susceptible to, sheath blight.

2. The method of claim 1, further comprising selecting a rice plant, or a field of rice plants comprising, or susceptible to sheath blight before applying said effective amount of the benzobicyclon and/or benzobicyclon hydrolysate.

3. The method of claim 1, wherein the effective amount of the benzobicyclon and/or benzobicyclon hydrolysate is applied after permanent flood establishment in a rice field.

4. The method of claim 1, wherein the benzobicyclon and/or benzobicyclon hydrolysate is applied rate of 8.4-12.6 oz./acre or 100-150 grams/acre.

5. The method of claim 1, comprising applying an effective amount of benzobicyclon and/or benzobicyclon hydrolysate, and one or more active ingredients to a rice seed, a rice plant, or a field of rice plants comprising, or susceptible to said causal agent of sheath blight.

6. The method of claim 5, wherein the one or more active ingredients comprises azoxystrobin, trifloxystrobin, propiconazole, difenconazole, fluxapyroxad, flutolanil, and/or inpyrfluxam.

7. The method of claim 5, wherein the one or more active ingredients are applied after the benzobicyclon and/or benzobicyclon hydrolysate is applied.

8. The method of claim 1, wherein the benzobicyclon and/or benzobicyclon hydrolysate is in liquid form.

9. The method of claim 1, wherein the benzobicyclon and/or benzobicyclon hydrolysate is in solid form.

10. The method of claim 9, wherein the solid form is a granule and the granule further comprises an acetolactate synthase (ALS) inhibitor.

11. The method of claim 10, wherein the ALS inhibitor is halosulfuron-methyl.

12. A method for preventing, treating and/or controlling Rhizoctonia solani comprising applying an effective amount of benzobicyclon and/or benzobicyclon hydrolysate to an area comprising, or susceptible to, Rhizoctonia solani.

13. The method of claim 12, further comprising selecting an area comprising, or susceptible to, Rhizoctonia solani.

14. The method of claim 12, comprising applying an effective amount of benzobicyclon and/or benzobicyclon hydrolysate and one or more active ingredients to an area comprising, or susceptible to, Rhizoctonia solani.

15. The method of claim 14, wherein the one or more active ingredients comprises azoxystrobin, trifloxystrobin, propiconazole, difenconazole, fluxapyroxad, flutolanil, and/or inpyrfluxam.

16. The method of claim 14, wherein the one or more active ingredients are applied after the benzobicyclon and/or benzobicyclon hydrolysate is applied.
